(19) United States
(12) Patent Application Publication
(10) Pub. No.: US 2023/0048364 A1
(43) Pub. Date: Feb. 16, 2023

(54) Relaying protocol in a cellular telecommunications network

(71) Applicant: ORANGE, ISSY LES MOULINEAUX (FR)

(72) Inventors: Nadège Varsier, Chatillon Cedex (FR); Quentin Lampin, Chatillon Cedex (FR)

(21) Appl. No.: 17/784,381

(22) PCT Filed: Dec. 3, 2020
(86) PCT No.: PCT/FR2020/052275

§ 371 Date: Jun. 10, 2022

(30) Foreign Application Priority Data
Dec. 12, 2019 (FR) 1914286

(51) Int. Cl. H04W 74/08

(52) U.S. Cl. CPC H04W 74/0833; H04W 88/04

(57) ABSTRACT

An application method implemented by a device desiring to be an applicant for relaying data between an object and a base station in a cellular network, the object and the device being synchronized and connected to the base station. The device emits a request, over a random-access channel, to request resources of the network to relay the data, the request including an identifier of the object. If the base station selects a device from among the applicant devices, it allocates resources in the network for this device and sends a positive response to the selected device.

### PRIOR ART

The invention relates to the general field of telecommunications networks, and more specifically to that of the relaying of data in a cellular telecommunications network. It is preferably but without limitation applicable in the context of D2D (Device-To-Device network).

In the current context of continuous growth of the number of connected objects, cellular telecoms networks particularly adapted to these connected objects have come into existence. These cellular networks are sometimes referred to by the name Cellular IoT (Internet of Things). The networks LTE-M (Long Term Evolution for Machines) and NB-IoT (Narrowband IoT) developed by the 3GPP (Third Generation Partnership Project) are in particular an integral part of the new radio (NR) 5G standardization process; they have the capacity to meet the specific connectivity requirements of these objects: they support a very large number of objects, meet cost and power consumption limitations, a designed for the sporadic sending of small data packets etc.

When a connected object is too far from the base station, or when it is separated from the base station, particularly by obstacles, the conditions for direct connection of this object to the base station may be difficult, or even impossible.

To face this problem, relaying solutions have been envisioned. In such a configuration, a relay device, hereinafter sometimes simply called a relay, relays the data between the connected object and the base station, either in the uplink direction (data sent by the connected object to the base station) or in the downlink direction (data sent by the base station to the connected object), or in both directions.

This relay device is typically a user device of smartphone type near the connected object and less limited in power than the connected object.

Two types of configuration exist when D2D relaying is involved. The first configuration is that in which the relays would be specifically deployed by the mobile network operator. These relays can be installed in strategic places where coverage is insufficient or propagation conditions are unfavorable.

This invention is applicable in both these configurations.

In an D2D LTE communication, as described in the 3GPP standard, 3 phases can be identified:

a phase of synchronizing and setting up the connection, wherein the mobile device will synchronize in real time with the base station if it is within network coverage or else directly with the relay if it is outside network coverage;
a phase of discovering and choosing the relay;
a phase of transmitting data to the relay.

The invention is more particularly located in the phase of discovering and choosing the relay.

In the current state of the art, two modes of discovery of the relay are standardized for LTE technology:

the “I'm here” mode A wherein the applicant relays manifest to indicate their presence and that they are able to relay a message, and
the “who is there?” mode B wherein the device seeking a relay manifests and sends a message to ask if there is a potential relay nearby.

For more information on these two modes, those skilled in the art may refer to the document “Proximity-Based Services (ProSe) (Release 14),” Third Generation Partnership Project (3GPP), Tech. Rep. TS 23.303, December 2016”.

In each of these two modes, and as shown in FIG. 1, several potential relay devices (or applicants) responding to a relaying request are liable to enter into competition.

In this figure, a connected object MTD is shown, three devices UE1, UE2, UE3 which are applicants for the role of relay and a base station BS in a scenario including:

sending (step A1) of a Request for Relay RR by the connected object MTD, in the situation where the mode B of discovering the relay is being used;
a first step (T1) wherein two devices UE1 and UE3 respond to the request RR, by sending a response RRR, generating a first collision;
a second step (T2) wherein two devices UE2 and UE3 respond to the request RR, generating a second collision; and
a third step (T3) wherein only the device UE1 responds to the request RR, this device UE1 being finally chosen to relay (step A2) the data between the device MTD and the base station BS after this contention process.

This mechanism has several drawbacks: it generates collisions, and the relay device UE1 finally chosen is not necessarily the best applicant from the point of view of the management of the resources of the cellular network.

### SUMMARY OF THE INVENTION

The invention concerns a relaying mechanism that does not have the drawbacks set out above.

Thus according to a first aspect, the invention relates to an application method implemented by a device desiring to be an applicant for relaying data between an object and a base station in a cellular network, the object and the device being synchronized and connected to the base station.

This method includes:

a step of emitting a request, over a random-access channel, to request resources of the network to relay these data, this request including an identifier of the object;
a step of receiving a response to said request coming from the base station;
the application of said device being chosen or rejected as a function of said response.

Correspondingly, the invention relates to a device desiring to be an applicant for relaying data between an object and a base station in a cellular network, the object and the device being synchronized and connected to the base station. This device includes:

a module for emitting a request, over a random-access channel, to request resources of the network to relay these data, this request including an identifier of the object;
a module for receiving a response to said request coming from the base station;
the application of said device being chosen or rejected as a function of said response.

According to a second aspect, the invention relates to a selection method implemented by a base station to select an applicant device for relaying data between an object and said base station in a cellular network, the object and the device being synchronized and connected to the base station. This method includes:

a step of receiving, coming from at least one device, of a request emitted by this device, over a random-access channel, to request resources of said network to relay said data, said request including an identifier from this object;
a step of selecting a single device from among said applicant devices;
a step of allocating resources in the network and sending a positive response to the selected device; and
a step of sending a negative response to the non-selected applicant devices.

Correspondingly, the invention relates to a base station configured to select an applicant device for relaying data between an object and the base station in a cellular network, the object and said device being synchronized and connected to the base station. This base station includes:

a module for receiving, coming from at least one device, of a request emitted by this device, over a random-access channel, to request resources of said network to relay said data, said request including an identifier of said object;
a module for selecting a single device from among the applicant devices;
a module for allocating resources in said network and sending a positive response to the selected device; and
a module for sending a negative response to the non-selected applicant devices.

Thus, and in general, the invention proposes that the choice of the relay, from among several applicant devices, to relay data between an object and the base station, in the uplink direction and/or in the downlink direction, be entrusted to the base station of the cellular network before the set-up of a connection.

This mechanism makes it possible to avoid collisions during the phase of discovering and selecting the relay. The contention between the potential relays is then done on the channel provided for this purpose (the PRACH—Physical Random Access CHannel). The contention is resolved by the base station, which makes it possible to avoid the hidden node problem or else duplications of connection requests and provides more efficient management of the radio resources.

The connected object within the meaning of the invention may be of any type. It can be of the same type as the applicant device/relay (smartphone, tablet) or not. It can also consist of a lighter device (connected watch, connected lightbulb etc.) In this document the expressions “connected object” and “device” are used to distinguish the relayed device and the relay device but this vocabulary imposes nothing on the structure or on the type of this equipment.

In the prior art, a device makes requests for resources over the random-access channel for its own needs. The invention here allows a device to make a request for resources for a third-party (connected object), in other words as a representative for this third party.

The invention allows the base station to refuse to allocate resources for such a request or to choose the relay device according to its own policy.

In an embodiment of the invention, the random-access channel is the PRACH (Physical Random Access CHannel) defined by the standard (ref: 3GPP TS 36.211 “Evolved Universal Terrestrial Radio Access (E-UTRA); Physical channels and modulation” release 8).

The invention thus proposes to modify the operation of the mode B relay discovery procedure, carried by the physical channel PSDC (Physical Sidelink Discovery Channel) and to extend the RACH to specify the identity of the connected object, in other words of the relayed object.

In an embodiment, the invention proposes an extended RACH preamble which may contain, as a supplement to the identifier making it possible to discriminate the relay device, an identifier making it possible to discriminate the relayed device of the Random Access-Radio Network Temporary Identifier (RA-RNTI) type.

In a variant of the invention, the request includes a request for resources from the network to transmit to the device data of its own.

This embodiment allows the device to ask, in the same request, for resources for its own needs and resources to relay the message of a third party.

For example in an embodiment of the invention, the mode B relay discovery procedure, carried by the physical channel PSDC (Physical Sidelink Discovery Channel) can be modified as follows:

the connected object (or more generally the device that wishes to be relayed) transmits a message containing an identifier, for example the Remote User ID.
the relay records the identifier and generates a PRACH preamble containing a cyclical prefix and a Zadoff-Chu sequence.

This RACH preamble may contain:

a RA-RNRTI (Radio Network Access Relay Temporary Identifier) identifier distinguishing the relay that emitted the message from the other emitters; and
a RA-RNTI identifier that distinguishes the relayed device.

The base station can transmit an extended ‘PRACH Response’ containing the RA-RNTI identifiers and the RA-RNRTI along with any resources allocated for the relaying.

In a first embodiment of this variant, the response sent by the base station to said device includes the identifier concerned by the response (namely that RA-RNTI of the relayed connected object or that RA-RNRTI of the relaying device). The device is thus able to determine whether or not the response of the base station relates to the resources requested to relay the data of the connected object or the resources requested for the device's own needs.

In a second embodiment of this variant, the response sent by the base station to said device includes a response as to the allocation of the resources requested to relay the data of the connected object and a response as to the allocation of the resources for said device's own data.

In an embodiment of the invention, the identifier of the object is a temporary or permanent identifier, where applicable a random number drawn by the object. This identifier is for example of IMEI (International Mobile Equipment Identity), TMSI (Temporary Mobile Subscriber Identity) or RA-RNTI (Random Access Radio Network Temporary Identifier) type.

In an embodiment of the invention, the identifier of the object is not mentioned explicitly in the request but it is encoded into said request, for example by a combination of a time slot and a frequency.

In a particular embodiment, the methods are implemented by computer programs.

Consequently, the invention also relates to a computer program on a recording medium, this program being able to be implemented in a device or more generally in a computer. This program includes instructions suitable for implementing an application method as described above.

The invention also relates to a computer program on a recording medium, this program being able to be implemented in a base station or more generally in a computer. This program includes instructions suitable for implementing a selecting method as described above.

Each of these programs can use any programming language, and be in the form of source code, object code, or intermediate code between source code and object code, such as in a partially compiled form, or in any other desirable form.

The invention also relates to an information medium or a recording medium readable by a computer, and including instructions of a computer program as mentioned above.

The information or recording media can be any entity or device capable of storing the programs. For example the media may include a storage means, such as a ROM, for example a CD-ROM or a microelectronic circuit ROM, or else a magnetic recording means, for example a diskette (floppy disk) or a hard disk, or a flash memory.

Moreover, the information or recording media can be transmissible media such as an electrical or optical signal, which can be conveyed via an electrical or optical cable, by radio link, by wireless optical link or by other means.

The programs according to the invention can in particular be downloaded over a network of Internet type.

Alternatively, each information or recording medium can be an integrated circuit wherein a program is incorporated, the circuit being suitable for executing or for being used in the execution of one of the methods in accordance with the invention.

### BRIEF DESCRIPTION OF THE DRAWINGS

Other features and advantages of this invention will become apparent from the description given below, with reference to the appended drawings which illustrate an exemplary embodiment thereof devoid of any limitation. In the figures:

FIG. 1 already described illustrates a relaying mechanism of the prior art;

FIG. 2 shows a device and a base station in accordance with a particular embodiment of the invention in their environment;

FIG. 3 illustrates a random-access mechanism in accordance with the prior art;

FIG. 4 shows an application method and a selecting method in accordance with a particular embodiment of the invention;

FIG. 5 shows an application method and a selecting method in accordance with another particular embodiment of the invention;

FIG. 6A shows the functional architecture of a device in accordance with a particular embodiment of the invention;

FIG. 6B shows the functional architecture of a base station in accordance with a particular embodiment of the invention;

FIG. 7A shows the hardware architecture of a device in accordance with a particular embodiment of the invention; and

FIG. 7B shows the hardware architecture of a base station in accordance with a particular embodiment of the invention.

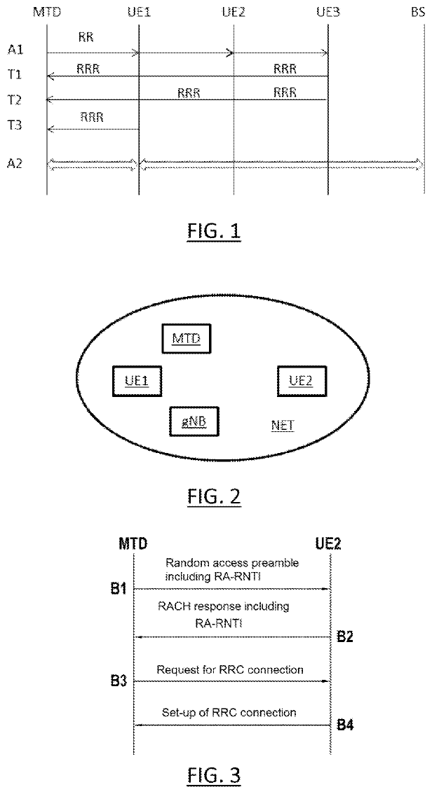

### DESCRIPTION OF THE EMBODIMENTS

FIG. 2 shows a connected object MTD, two devices UE1, UE2 and a base station gNB in a cellular network NET, the devices UE1, UE2 and the base station gNB being in accordance with embodiments of the invention. The invention is described thus in the example of 5G. It is applicable in the same way in a 4G network, the base stations being of eNB type.

It is assumed that the devices UE1, UE2 and the connected object MTD are synchronized and connected to the base station gNB.

There will now be a reminder, with reference to FIG. 3, of the random-access mechanism implemented in accordance with the prior art, in such a network.

In a known manner in such a network, when a terminal T (generic name chosen to denote the device UE1, UE2 or the connected object MTD) wishes to transmit data over the network, it emits a request on a random-access PRACH channel to request resources from the network. These resources are managed by the base station gNB.

More precisely, and as described in the document TS 36.211, the terminal randomly chooses a preamble from among a set of available preambles reserved for a contention process and it transmits its request (step B1) in a short message in the first available time slot of the random access. The sending of this short message is done cyclically.

These requests are listened to and received by the base station gNB which decides whether or not to allocate the requested resources. It responds (step B2) to this PRACH request by a RAR (Random Access Response) message, this message indicating whether the requested resources have been allocated or refused.

In a manner known by those skilled in the art, this response message also includes a time alignment TA which allows the terminal to synchronize. The terminal adjusts its transmission time to the TA received and transmits (step B3) a Radio Resource Control (RRC) message through the PUSCH (Physical Uplink Shared Channel) up channel. If the base station gNB correctly decodes the message sent in step B3, it transmits (step B4) the contention resolution to the terminal T. If the terminal T has not correctly received the RAR response or the contention resolution within a set time window, it starts the random access procedure again in step B1.

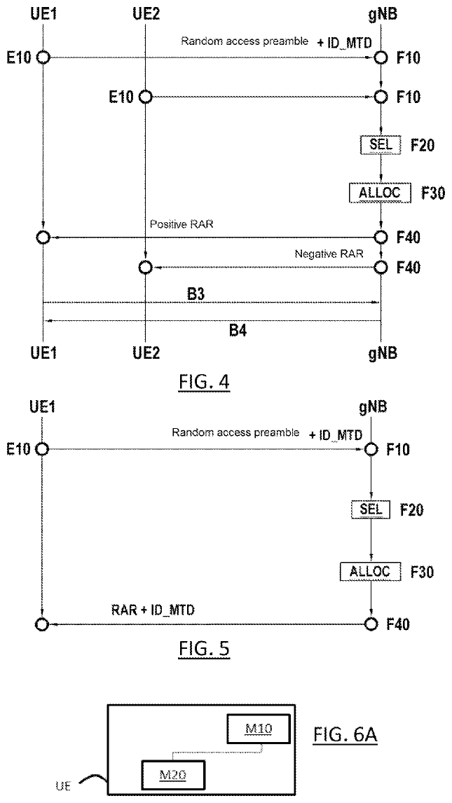

FIG. 4 illustrates an application method and a selection method in accordance with a first particular embodiment of the invention.

It is assumed that the devices UE1, UE2 and the connected object MTD are connected and synchronized with the base station gNB.

It is assumed in this example that the devices UE1 and UE2 have received a RR (Request for Relay) broadcast by the connected object, to relay a message from this object intended for the base station.

It is assumed in this example that the device UE1 and the device UE2 each wish to be an applicant for relaying a message of the connected object MTD.

In the exemplary embodiment described here, if the connected object broadcasts the message to be relayed at the same time as the relay request, each of the devices UE1 and UE2 stores this message in its memory while waiting to find out whether or not its application has been chosen by the base station.

In accordance with the invention, during a step E10, each of the devices UE1, UE2 emits a request over the random-access PRACH channel to request resources from the network to relay this message. This request includes an identifier ID_MTD of the connected object, for example its IMEI, TMSI or RA-RNTI identifier.

These requests are received by the base station gNB during a step F10.

During a step F20, the base station gNB selects a single device to relay the message of the connected object MTD.

In the exemplary embodiment described here, it selects the first applicant, namely the device UE1.

During a step E30 known to those skilled in the art, the base station gNB allocates resources in the network to allow the device UE1 to relay the message of the connected object.

During a step E40, it sends a positive RAR (Random Access Response) including the resources allocated to the device UE1 and a negative response to the device UE2. This RAR is identical to the RAR of the prior art previously described with reference to the step B2 of FIG. 3.

Consequently, in this first embodiment, only the step B1 is modified. The modification consists in modifying the PRACH preamble to contain an identifier of the relayed connected object MTD.

The devices UE1, UE2 receive this response during a step F20. The device UE1 understands that it has been chosen to relay the message of the connected object MTD and the device UE2 understands that its request has been rejected.

The random-access mechanism continues as previously described with reference to the steps B3 and B4 of FIG. 3.

FIG. 5 illustrates an application method and a selection method in accordance with a second particular embodiment of the invention.

In this embodiment, it is assumed that the device UE1 wishes to be an applicant for relaying a message of the connected object MTD and that this device UE1 also wishes to request resources for its own data.

In this embodiment of the invention, the device UE1 emits a single request over the random-access PRACH channel to request (i) resources from the network to relay the message of the connected object and (ii) resources to transmit its own data. In accordance with the invention this request includes an identifier ID_MTD of the connected object, for examples its IMEI, TMSI or RA-RNTI identifier.

This request is received by the base station gNB during a step F10.

During a step F20, the base station gNB decides whether or not to select the device UE1 to relay the message of the connected object MTD. If such is the case, the base station gNB allocates (step F30) resources in the network to allow the device UE1 to relay the message of the connected object.

During this same F20, the base station gNB decides whether or not to allocate resources to the device UE1 for its own needs. If such is the case, the base station gNB allocates (step F30) resources to the device UE1 for its own data.

In this embodiment of the invention, the base station responds (F40) to the device UE1 on the two allocation requests. This response can be done in a single RAR message or as shown in FIG. 5 in two RAR messages.

In the embodiment described here, the RAR to the request for allocation of resources to relay the data of the connected object MTD includes the identifier ID_MTD of this object.

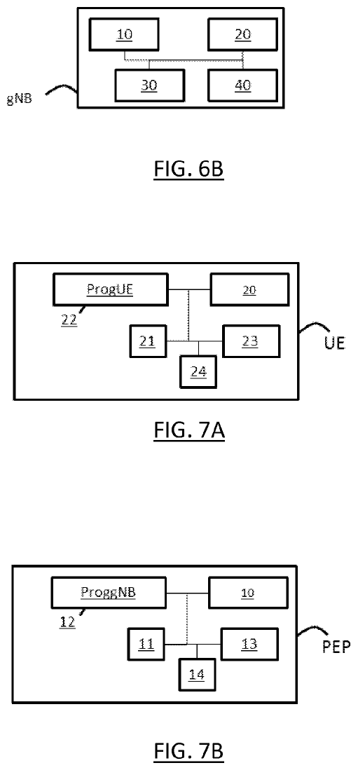

FIG. 6A functionally represents a device UE desiring to be an applicant for relaying data between an object and a base station in a cellular network, this device being in accordance with a particular embodiment of the invention. It includes:

a module ME10 configured to emit a request, over a random-access channel, to request resources of a network to relay data between an object and a base station, this request including an identifier of this object;
a module ME20 for receiving a response to this request coming from the base station;
the application of the device being chosen or rejected as a function of said response.

FIG. 6B functionally represents a base station gNB configured to select an applicant device to relay data between an object and this base station in a cellular network, the object and the device being synchronized and connected to this base station. It includes:

a module MF10 for receiving, coming from at least one device, of a request transmitted by this device, over a random-access channel), to request resources of said network to relay said data, this request including an identifier of the object;
a module MF20 for selecting a single device (UE1) from among said applicant devices;
a module MF30 for allocating said resources in said network and sending a positive response to said selected device; and
a module MF40 for sending a negative response to said unselected applicant devices.

FIG. 7A shows the hardware architecture of a device UE in accordance with the invention. In the embodiment described here, this device UE has the hardware architecture of a computer. It particularly comprises a processor 20, a random-access memory 21, a read-only memory 22, a non-volatile flash memory 23 and communication means 24. Such means are known per se and are not described in further detail here.

The read-only memory 22 constitutes a recording medium in accordance with the invention, readable by the processor 20 and on which is here recorded a computer program ProgUE in accordance with the invention, this program particularly including instructions making it possible, when they are executed by the processor 20, to:
detect a request for relay;
emit a request, over a random-access channel to request resources of a network to relay data between an object and a base station, this request including an identifier of this object;
receive a response to this request coming from the base station;
understand that the application of the device has been chosen or rejected as a function of this response;
implementing the steps B3 and B4 of the random access procedure described with reference to FIG. 3.

FIG. 7B shows the hardware architecture of a base station gNB in accordance with the invention. In the embodiment described here, this base station gNB has the hardware architecture of a computer. It particularly comprises a processor 10, a random-access memory 11, a read-only memory 12, a non-volatile flash memory 13 and communication means 14. Such means are known per se and are not described in further detail here.

The read-only memory 12 constitutes a recording medium in accordance with the invention, readable by the processor 10 and on which is here recorded a computer program ProgNB in accordance with the invention, this program particularly including instructions making it possible, when they are executed by the processor 20, to:
receive, coming from at least one device, a request emitted by this device, over a random-access channel, to request resources of said network to relay said data, this request including an identifier of the object;
select a single device (UE1) from among said applicant devices;
allocate resources in said network and send a positive response to the selected device;
send a negative response to the applicant devices not selected;
implement steps B3 and B4 of the random access procedure described with reference to FIG. 3.

1. An application method implemented by a device desiring to be an applicant for relaying data between an object and a base station in a cellular network, the object and said device being synchronized and connected to the base station, this method including:
emitting a request, over a random-access channel, to request resources of said network to relay said data, said request corresponding to an application to relay the data and including an identifier of said object;
receiving a response to said request coming from said base station; and
the device relaying the data or not relaying the data as a function of said response.

2. The application method as claimed in claim 1 wherein said random-access channel is the PRACH (Physical Random-Access Channel).

3. The application method as claimed in claim 1 wherein said request includes a request for resources from said network to transmit to the device data of its own.

4. The application method as claimed in claim 1 wherein said identifier is a temporary or permanent identifier.

5. The application method as claimed in claim 1 wherein said identifier is encoded into said request by a combination of a time slot and a frequency.

6. A selection method implemented by a base station to select an applicant device for relaying data between an object and said base station in a cellular network, the object and said device being synchronized and connected to said base station, this method including:
receiving, from at least one device, a request emitted by this device, over a random-access channel, to request resources of said network to relay said data, said request including an identifier of said object;
selecting a single device from among said at least one devices;
allocating resources in said network and sending a positive response to the selected device; and
sending a negative response to any non-selected device of the at least one device for relaying the data.

7. The selection method as claimed in claim 6 wherein said positive response further includes said identifier of the object.

8. The selection method as claimed in claim 6 wherein said request further includes a request for resources for said device's own data, and the method includes sending a response as to the allocation of the resources for the device's own data.

9. A device desiring to be an applicant for relaying data between an object and a base station in a cellular network, the object and said device being synchronized and connected to the base station, this device including:
a processor; and
a non-transitory computer readable medium comprising instructions stored thereon which when executed by the processor configure the device to:
emit a request, over a random-access channel, to request resources of said network to relay these data, this request including an identifier of said object;
receive a response to said request coming from said base station;
relay the data or not relaying the data as a function of said response.

10. A base station configured to select an applicant device for relaying data between an object and said base station in a cellular network, the object and said device being synchronized and connected to said base station, the base station including:
a processor; and
a non-transitory computer readable medium comprising instructions stored thereon which when executed by the processor configure the base station to:
receive, from at least one device, a request emitted by this device, over a random-access channel, to request resources of said network to relay said data, said request including an identifier of said object;
select a single device from among said at least one device;
allocate said resources in said network and send a positive response to said selected device; and
sending a negative response to any non-selected applicant device among the at least one device for relaying the data.

11. A non-transitory computer readable medium having stored thereon instructions which, when executed by a processor, cause the processor to implement the application method of claim 1.

12. A non-transitory computer readable medium having stored thereon instructions which, when executed by a processor, cause the processor to implement the selection method of claim 6.
